(19) United States
(12) Patent Application Publication
(10) Pub. No.: US 2024/0039451 A1
(43) Pub. Date: Feb. 1, 2024

(54) MOTOR CONTROL APPARATUS AND MOTOR CONTROL SYSTEM

(71) Applicant: Hitachi Astemo, Ltd., Ibaraki (JP)

(72) Inventors: Haruhiko FUJITA, Hitachinaka-shi, Ibaraki (JP); Takuya USUI, Hitachinaka-shi, Ibaraki (JP); Daisuke GOTO, Hitachinaka-shi, Ibaraki (JP)

(21) Appl. No.: 18/266,041

(22) PCT Filed: Dec. 3, 2021
(86) PCT No.: PCT/JP2021/044460

§ 371 Date: Jun. 8, 2023

(30) Foreign Application Priority Data
Dec. 15, 2020 (JP) 2020-207400

(51) Int. Cl. H02P 29/028; H02M 1/32

(52) U.S. Cl. CPC H02P 29/028; H02M 1/325

(57) ABSTRACT

A motor control apparatus controls a brake motor. The motor control apparatus includes a first motor driving portion, a first control portion, a second motor driving portion, and a second control portion. The second control portion is connected to the first control portion. The second control portion has s self-diagnosis function not provided to the first control portion. The second control portion monitors a state of a phase current in the first motor driving portion. For example, the second control portion determines that the first control portion is abnormal in a case where the waveform of the phase current in the first motor driving portion is outside a range of an expected current waveform.

### TECHNICAL FIELD

The present disclosure relates to a motor control apparatus and a motor control system.

### BACKGROUND ART

PTL 1 discloses that a driving control system of a motor is duplicated and redundantly arranged with the aim of maintaining functionality of an electric power steering according to requirements of autonomous driving, functional safety, and the like of a vehicle.

### CITATION LIST

### Patent Literature

PTL 1: Japanese Patent Application Public Disclosure No. 2016-171664

### SUMMARY OF INVENTION

### Technical Problem

In the redundantly arranged driving control of the motor like PTL 1, each system should be equipped with a built-in function capable of self-diagnosing an abnormality detection function to allow each system to reliably detect an abnormality in itself, and the cost may increase accordingly.

### Solution to Problem

An object of one aspect of the present invention is to provide a motor control apparatus and a motor control system capable of achieving a cost reduction while establishing redundancy.

According to one aspect of the present invention, a motor control apparatus includes a first motor driving portion configured to drive a motor, a first control portion connected to the first motor driving portion and connected to a controller of a vehicle, and a second control portion connected to the first control portion. The second control portion has a more accurate self-diagnosis function than the first control portion or has a self-diagnosis function not provided to the first control portion. The second control portion is connected to the controller of the vehicle and configured to monitor a state of the first motor driving portion. The motor control apparatus further includes a second motor driving portion connected to the second control portion and configured to drive the motor.

Further, according to one aspect of the present invention, a motor control system includes a motor and a motor controller configured to control the motor. The motor controller includes a first motor driving portion configured to drive the motor, a first control portion connected to the first motor driving portion, and a second control portion connected to the first control portion. The second control portion has a more accurate self-diagnosis function than the first control portion or has a self-diagnosis function not provided to the first control portion. The second control portion is configured to monitor a state of the first motor driving portion. The motor controller further includes a second motor driving portion connected to the second control portion and configured to drive the motor. The motor control system further includes a vehicle controller connected to the first control portion and the second control portion.

According to the one aspect of the present invention, a cost reduction can be achieved while redundancy is established.

### BRIEF DESCRIPTION OF DRAWINGS

FIG. 1 is a block diagram illustrating a motor control system and a motor control apparatus according to an embodiment.

FIG. 2 illustrates characteristic lines indicating one example of time-series changes (waveforms) of phase currents (a U phase, a V phase, and a W phase) in a first motor driving portion.

FIG. 3 is a flowchart illustrating processing performed by a second control portion (M_ECU_2) illustrated in FIG. 1.

FIG. 4 is a flowchart illustrating processing performed by a controller (a higher-level control apparatus) of a vehicle illustrated in FIG. 1.

FIG. 5 is a flowchart illustrating processing performed by a first control portion (M_ECU_1) illustrated in FIG. 1.

### DESCRIPTION OF EMBODIMENTS

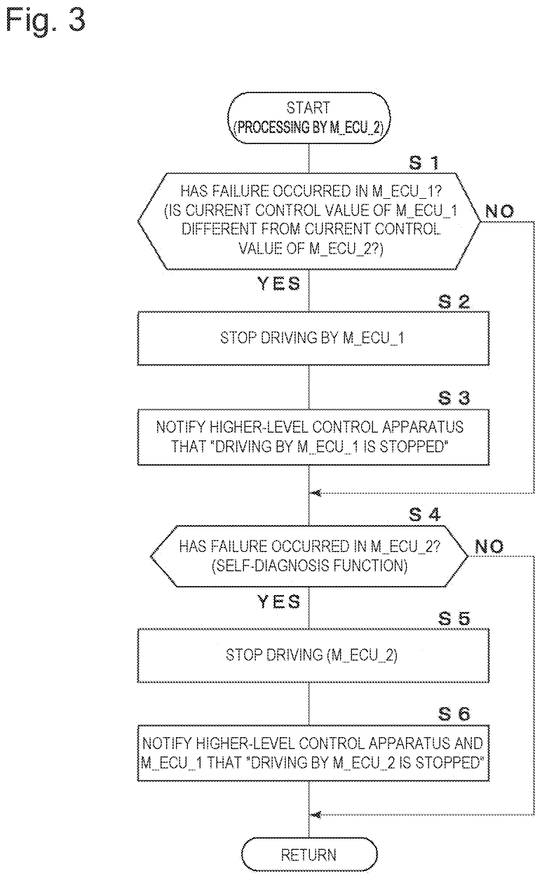

In the following description, a motor control apparatus and a motor control system according to an embodiment will be described with reference to the accompanying drawings, citing an example in which they are mounted on a four-wheeled automobile. Individual steps in flowcharts illustrated in FIGS. 3 to 5 will be each represented by the symbol “S” (for example, each step will be indicated like “step 1”=“S1”).

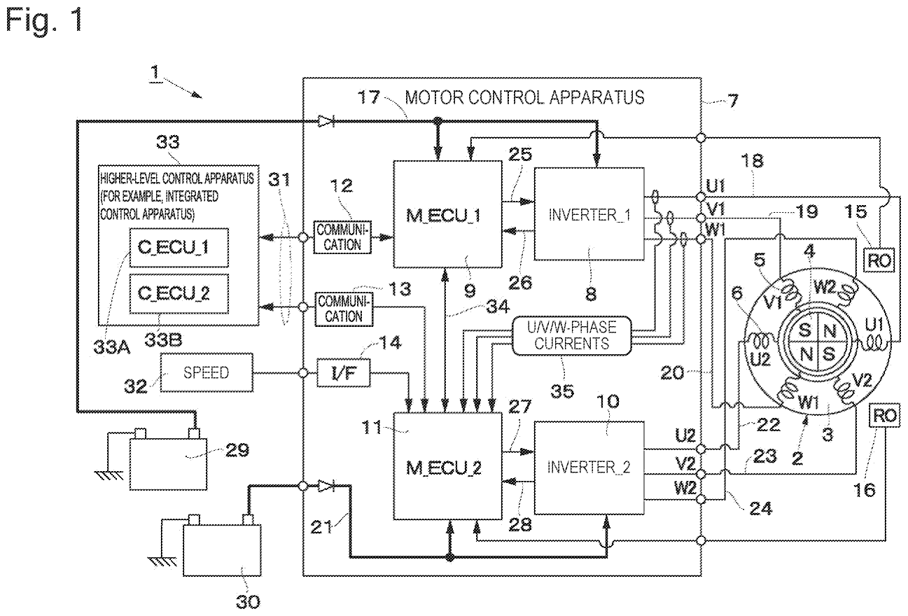

In FIG. 1, a motor control system 1 mounted on a vehicle (an automobile) includes a brake motor 2 as a motor, a motor control apparatus 7 as a motor controller, and a higher-level control apparatus 33 as a controller of the vehicle (a vehicle controller). In the embodiment, the higher-level control apparatus 33 corresponds to an integrated controller that determines motion control of the vehicle. Hereinafter, the higher-level control apparatus 33 will be referred to as an integrated control apparatus 33.

The brake motor 2 controls (drives) an electric brake mechanism (not illustrated) that provides a braking force to the vehicle. The electric brake mechanism corresponds to, for example, an electric disk brake including an electric caliper that presses brake pads against a disk rotor using an electric motor. The brake motor 2 includes a stator 3 serving as a stationary element, and a rotor 4 serving as a permanent magnet rotator rotatably provided at a central portion of the stator 3. The rotor 4 of the brake motor 2 is connected to, for example, a rotational shaft of a not-illustrated rotation-linear motion conversion mechanism. The rotation of the brake motor 2 (the rotor 4) is converted into a liner motion by the rotation-linear motion conversion mechanism, and causes the brake pads of the electric brake mechanism to be moved toward and separated from the disk rotor.

The brake motor 2 includes two winding sets 5 and 6 to secure redundancy. More specifically, the brake motor 2 is configured as a three-phase synchronous motor including the first winding set 5 constituted by three-phase windings U1, V1, and W1 connected via a star connection and the second winding set 6 constituted by three-phase windings U2, V2, and W2 also connected via a star connection, i.e., configured as a six-phase motor having dual three-phase windings (a six-phase motor that generates a torque using two three-phase coil systems for the single rotor 4). The first winding set 5 and the second winding set 6 are provided on the stator 3 in a state of being isolated from each other.

The electric brake mechanism (the electric brake) is not limited to the electric disk brake, and may be embodied using, for example, an electric drum brake including an electric cylinder that provides a braking force by pressing shoes against a drum by an electric motor. Alternatively, the electric brake mechanism (the electric brake) may be embodied using a hydraulic disk brake including an electric motor (a hydraulic disk brake equipped with an electric parking brake function), or a cable puller-type electric parking brake that actuates the application of a parking brake by pulling a cable using an electric motor. In other words, various types of electric brakes (electric brake mechanisms) can be used as the electric brake (the electric brake mechanism), as long as the electric brake is configured to be able to press (thrust) a frictional member (pads or shoes) against a rotational member (a rotor or a drum) based on driving of an electric motor (an electric actuator), and provide and release a braking force (maintain and release a pressing force).

The motor control apparatus 7 as a motor controller controls the brake motor 2. More specifically, the motor control apparatus 7 controls driving of each of the windings U1, V1, and W1 of the first winding set 5 and each of the windings U2, V2, and W2 of the second winding set 6 of the brake motor 2. For this purpose, the motor control apparatus 7 includes a first driving control system (a first motor driving portion 8 and a first control portion 9) that controls the driving of the first winding set 5 (U1, V1, and W1) and a second driving control system (a second motor driving portion 10 and a second control portion 11) that controls driving of the second winding set 6 (U2, V2, and W2).

In other words, the motor control apparatus 7 includes the first motor driving portion 8, the first control portion 9, the second motor driving portion 10, and the second control portion 11. Further, the motor control apparatus 7 includes a first communication interface 12, a second communication interface 13, and an interface (I/F) 14.

The first motor driving portion 8 drives the brake motor 2. The first motor driving portion 8 is constituted by, for example, an inverter circuit. The first motor driving portion 8 is connected to a first power source 29 of the vehicle, such as a power storage device (a battery), via a first direct-current power line 17. Along therewith, the first motor driving portion 8 is connected to the windings U1, V1, and W1 of the first winding set 5 of the brake motor 2 via a U1-phase power line 18, a V1-phase power line 19, and a W1-phase power line 20, respectively. Further, the first motor driving portion 8 is connected to the first control portion 9 via signal lines 25 and 26.

The first motor driving portion 8 (the inverter circuit) includes a plurality of switching elements constituted by, for example, a transistor, a field-effect transistor (FET), and an insulated gate bipolar transistor (IGBT). Opening/closing of each of the switching elements of the first motor driving portion 8 (the inverter circuit) is controlled based on an instruction signal (for example, a pulse signal) from the first control portion 9. When driving the brake motor 2, the first motor driving portion 8 (the inverter circuit) generates three-phase (the U phase, the V phase, and the W phase) alternating-current power from direct-current power based on the instruction signal from the first control portion 9, and supplies this alternating-current power to the first winding set 5 (each of the windings U1, V1, and W1) of the brake motor 2.

The first control portion 9 is connected to the first motor driving portion 8. The first control portion 9 is also called an ECU (Electronic Control Unit), and includes a microcomputer serving as an arithmetic circuit (a CPU). The first control portion 9 corresponds to a first motor ECU (M_ECU_1), and includes, for example, a power circuit (a Power Management IC), the microcomputer, and a driver circuit (a Pre Driver). The first control portion 9 is connected to the first power source 29 of the vehicle via the first direct-current power line 17, and is also connected to the first motor driving portion 8 via the signal lines 25 and 26. The first control portion 9 drives the brake motor 2 (rotates it in a forward/reverse direction) by controlling (performing switching control on) the first motor driving portion 8 (the inverter circuit).

The first control portion 9 is connected to a rotational sensor 15 for performing feedback control on the rotation of the rotor 4 of the brake motor 2. The rotational sensor 15 detects, for example, a rotational angle of the rotor 4 of the brake motor 2. The first control portion 9 is connected to a vehicle data bus 31 serving as a communication line via the first communication interface 12. The vehicle data bus 31 constitutes, for example, a CAN (Controller Area Network) as a communication network mounted on the vehicle body. Various kinds of ECUs of a large number of electronic apparatuses mounted on the vehicle, such as the integrated control apparatus 33, a suspension control apparatus (not illustrated), and a steering control apparatus (not illustrated), car out in-vehicle multiplex communication with one another via the vehicle data bus 31.

The second motor driving portion 10 also drives the brake motor 2, similarly to the first motor driving portion 8. The second motor driving portion 10 is also constituted by, for example, an inverter circuit, similarly to the first motor driving portion 8. The second motor driving portion 10 is connected to a second power source 30 of the vehicle, such as a power storage device (a battery), via a second direct-current power line 21. Along therewith, the second motor driving portion 10 is connected to the windings U2, V2, and W2 of the second winding set 6 of the brake motor 2 via a U2-phase power line 22, a V2-phase power line 23, and a W2-phase power line 24, respectively. The second power source 30 is a power source different from the first power source 29 connected to the first motor driving portion 8 and the first control portion 9 (a power source in a different system). The motor control system 1 has a dual system configuration as the supply route of the power source in this manner, thereby securing redundancy.

Further, the second motor driving portion 10 is connected to the second control portion 11 via signal lines 27 and 28. The second motor driving portion 10 (the inverter circuit) also includes a plurality of switching elements constituted by, for example, a transistor, a field-effect transistor (FET), and an insulated gate bipolar transistor (IGBT). Opening/closing of each of the switching elements of the second motor driving portion 10 (the inverter circuit) is controlled based on an instruction signal (for example, a pulse signal) from the second control portion 11. When driving the brake motor 2, the second motor driving portion 10 (the inverter circuit) generates three-phase (the U phase, the V phase, and the W phase) alternating-current power from direct-current power based on the instruction signal from the second control portion 11, and supplies this alternating-current power to the second winding set 6 (each of the windings U2, V2, and W2) of the brake motor 2.

The second control portion 11 is connected to the second motor driving portion 10. The second control portion 11 is also called an ECU (Electronic Control Unit), and includes a microcomputer serving as an arithmetic circuit (a CPU). The second control portion 11 corresponds to a second motor ECU (M_ECU_2), and includes, for example, a power circuit (a Power Management IC), the microcomputer, and a driver circuit (a Pre Driver). The second control portion 11 is connected to the second power source 30 of the vehicle via the second direct-current power line 21, and is also connected to the second motor driving portion 10 via the signal lines 27 and 28. The second control portion 11 drives the brake motor 2 (rotates it in a forward/reverse direction) by controlling (performing switching control on) the second motor driving portion 10 (the inverter circuit).

The second control portion 11 is connected to a rotational sensor 16 for performing feedback control on the rotation of the rotor 4 of the brake motor 2. The rotational sensor 16 detects, for example, the rotational angle of the rotor 4 of the brake motor 2. The rotational sensor 16 is also a rotational sensor different from the rotational sensor 15 connected to the first motor driving portion 8. Due to that, redundancy is secured. The second control portion 11 is connected to the vehicle data bus 31 via the second communication interface 13. Further, the second control portion 11 is connected to a wheel speed sensor 32 via the interface 14. The wheel speed sensor 32 is, for example, a sensor that detects a rotational speed of a wheel.

The integrated control apparatus 33 is connected to the first control portion 9 and the second control portion 11. More specifically, the integrated control apparatus 33 is connected to the first control portion 9 and the second control portion 11 via the vehicle data bus 31 called a CAN. The integrated control apparatus 33 is, for example, an integrated control apparatus (an integrated ECU) that determines vehicle motion control for moving the vehicle according to a target trajectory acquired from an autonomous driving control apparatus (an autonomous driving ECU). The integrated control apparatus 33 outputs a control instruction (for example, a control instruction regarding autonomous driving) required for each actuator control apparatus (an actuator ECU), such as a motor driving apparatus (a motor driving ECU), a brake control apparatus (a brake ECU), a steering control apparatus (a steering ECU), or a suspension control apparatus (a suspension ECU).

In the embodiment, the motor control apparatus 7 serves as both the motor driving apparatus (the motor driving ECU) that drives the brake motor 2 and the brake control apparatus (the brake ECU) in charge of integrated control regarding the brake. In other words, the motor control apparatus 7 (the brake motor control ECU) is integrally configured as a control apparatus having both the motor driving function and the brake control function. However, the motor control apparatus 7 is not limited thereto, and the motor driving apparatus (the motor driving ECU) and, for example, the brake control apparatus (the brake ECU) may be configured as individual separate apparatuses (separate units) from each other.

The integrated control apparatus 33 is also called a central control apparatus (a central ECU), and corresponds to a higher-level control apparatus superior to the motor control apparatus 7. The integrated control apparatus 33 also includes a microcomputer serving as an arithmetic circuit (a CPU). In this case, the integrated control apparatus 33 has a dual-core (dual-circuit) configuration so as to be able to, for example, monitor whether a difference lies in processing result by each other along with performing the same processing in parallel. In other words, the integrated control apparatus 33 includes two control portions 33A and 33B (a first central ECU (C_ECU_1) and a second central ECU (C_ECU_2)).

Then, the driving control unit of the motor discussed in the above-described patent literature, PTL 1 employs a six-phase motor having six sets of windings to secure redundancy as a motor for generating a steering assist torque. In the case of such a configuration, it is conceivable to dispose ASILD chipsets (power management ICs that monitor microcomputers, microcomputers, and pre-drivers) prepared as completely independent two systems, and control three phases and the other three phases of the six-phase motor by different ASILD chipsets, respectively. In this case, the driving control unit of the motor can be configured to cause each system to carry out detection of its own abnormality in itself, and, if an abnormality is detected, cause the abnormal system to set this system itself to fail-open and the other system to generate a remaining torque corresponding to remaining 50%.

However, two expensive chipsets including a BIST (a built-in self-test circuit) capable of self-diagnosing the abnormality detection function should be prepared to allow each system to reliably detect an abnormality in itself in the configuration including full redundant-type two systems. As a result, the cost may increase.

In light thereof, in the embodiment, a primary channel serving as one of systems for securing the redundancy function is constituted by a self-contained chipset (for example, the ASILD class). On the other hand, an inexpensive chipset capable of achieving a main function although the safety function is not complete (for example, the QM to ASILB class) is employed for a secondary channel serving as remaining one of the systems. For example, an ASILB all-in-one chip (a power source, a microcomputer, and a pre-driver) is employed for the secondary channel.

Then, the ECU of the primary channel determines whether the main function of the secondary channel is achieved. In this case, the ECU of the primary channel determines whether the main function of the secondary channel is achieved based on whether motor phase currents (motor currents of the U, V, and W phases), which are a final output of the ECU of the secondary channel, conform with expected operations.

This allows an inexpensive device to be employed without using an expensive device in the embodiment. In this case, the inexpensive chipset may lead to a reduction in the safety function, but can contribute to a reduction in the size of the board because the component size is small. Then, since achieving a reduction in the size of the board, this chipset brings an advantage for, for example, packaging when employing a mechatronic combination actuator subjected to a strict space constraint. In other words, the embodiment can achieve a cost reduction while ensuring safety due to the redundant system, and further can achieve a reduction and miniaturization of components on the board.

For this reason, in the embodiment, the second control portion 11 is connected to the first control portion 9 via a communication line 34 (a communication line between CPUs). Further, the second control portion 11 has a more accurate self-diagnosis function than the first control portion 9. Alternatively, the second control portion 11 has a self-diagnosis function not provided to the first control portion 9. In other words, the first control portion 9 has a less accurate self-diagnosis function than the second control portion 11. Alternatively, the first control portion 9 has no self-diagnosis function. In the embodiment, assume that the first control portion 9 has no self-diagnosis function.

The first control portion 9 is connected to the integrated control apparatus 33 serving as the controller of the vehicle (the vehicle controller). The second control portion 11 is connected to the integrated control apparatus 33 connected to the first control portion 9. In other words, in the embodiment, both the first control portion 9 and the second control portion 11 are each connected to the integrated control apparatus 33.

The second control portion 11 monitors the state of the first motor driving portion 8. Accordingly, the first control portion 9 and the second control portion 11 are placed in a relationship of a slave ECU and a master ECU. The second control portion 11 monitors the states of phase currents in the first motor driving portion 8. Therefore, a phase-current monitor circuit 35 is connected to the U1-phase power line 18, the V1-phase power line 19, and the W1-phase power line 20 of the first motor driving portion 8. The phase-current monitor circuit 35 is connected to the second control portion 11, and the second control portion 11 monitors the phase currents in the first motor driving portion 8 by the phase-current monitor circuit 35. The second control portion 11 determines that the first control portion 9 is abnormal if, for example, the monitor value in the phase-current monitor circuit 35 falls out of a normal range and cannot be controlled according to the control instruction.

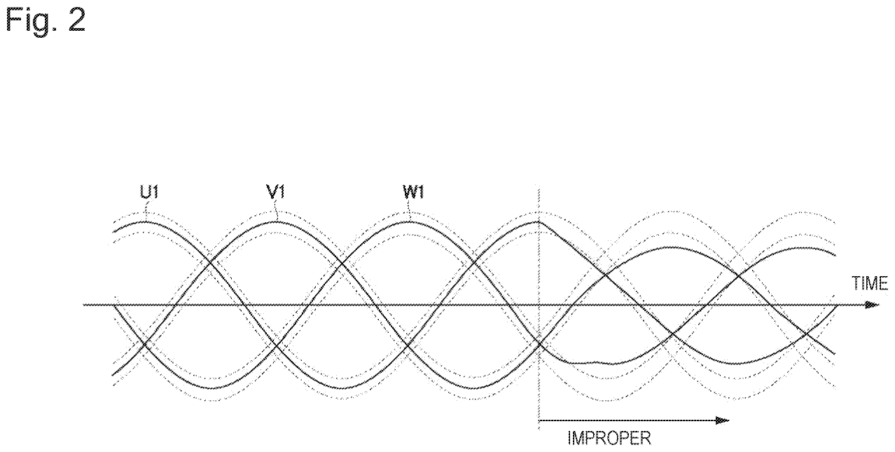

More specifically, the second control portion 11 determines that the first control portion 9 is normal if each of the waveforms of the phase currents in the first motor driving portion 8 is within a range of an expected current waveform, and determines that the first control portion 9 is abnormal if each of the waveforms of the phase currents in the first motor driving portion 8 is outside the range of the expected current waveform. FIG. 2 illustrates one example of time-series changes (waveforms) of the phase currents (the U phase, the V phase, and the W phase) in the first motor driving portion 8. In FIG. 2, the range of the expected current waveform is indicated by a long dashed double-short dashed line. The range of the expected current waveform can be set as a range of a current waveform satisfied when the first motor driving portion 8 and thus the first control portion 9 are in a proper state.

As understood from “IMPROPER” described in FIG. 2, the second control portion 11 determines that the first control portion 9 is abnormal when the waveform of the phase current in the first motor driving portion 8 falls out of the range of the expected waveform. In this manner, in the embodiment, an inexpensive chipset not supporting a self-diagnosis about abnormality detection is employed for the chipset of the first control portion 9 serving as the slave side, and the second control portion 11 having the self-diagnosis function, which serves as the master side, determines whether the behavior of the motor phase current on the slave side is normal or abnormal.

Then, the second control portion 11 stops the driving of the first motor driving portion 8 when the waveform of the phase current in the first motor driving portion 8 is outside the range of the expected current waveform. Further, the second control portion 11 notifies the integrated control apparatus 33 that the first control portion 9 is abnormal when the waveform of the phase current in the first motor driving portion 8 is outside the range of the expected current waveform. Further, the second control portion 11 determines that the second control portion 11 is normal or abnormal by the self-diagnosis function. The second control portion 11 stops the driving of the second motor driving portion 10 when determining that the second control portion 11 is abnormal by the self-diagnosis function.

The integrated control apparatus 33 detects that the second control portion 11 is abnormal if the second control portion 11 is determined to be abnormal by the self-diagnosis function of the second control portion 11. The integrated control apparatus 33 outputs a control instruction for driving the brake motor 2 to the first control portion 9 when the second control portion 11 is determined to be abnormal by the self-diagnosis function of the second control portion 11. Such control by the integrated control apparatus 33, control by the second control portion 11, and control by the first control portion 9, i.e., control processing illustrated in FIGS. 3 to 5 will be described in detail below.

The motor control apparatus and the motor control system of the four-wheeled automobile according to the embodiment are configured in the above-described manner, and operations thereof will be described next.

First, an operation when the first control portion 9 (the slave ECU) malfunctions will be described. When a failure has occurred in the first control portion 9, the motor phase-current waveform detected by the phase-current monitor circuit 35 deviates from the expected value. The second control portion 11 (the master ECU) determines that a failure has occurred in the first control portion 9 based on the fact that the motor phase-current waveform detected by the phase-current monitor circuit 35 deviates from the expected value.

When the motor phase-current waveform in the first motor driving portion 8 deviates from the expected value, examples of a possible cause therefor include a malfunction of the first power source 29 or an erroneous operation of the microcomputer or the pre-driver of the first control portion 9. The phase-current monitor circuit 35 detects that the motor phase-current waveform deviates from the expected value due to such a malfunction, an erroneous operation, or the like. In this case, the second control portion 11 detects that a current control value of the first motor driving portion 8 by the first control portion 9 does not match a current control value of the second control portion 11. Based thereon, the second control portion 11 determines that the first control portion 9 is abnormal.

The second control portion 11 stops the driving of the first motor driving portion 8 by the first control portion 9. Along therewith, the second control portion 11 notifies the integrated control apparatus 33 that a failure has occurred in the first control portion 9. After acquiring the notification from the second control portion 11 (the notification indicating that a failure has occurred in the first control portion 9), the integrated control apparatus 33 performs degradation control as necessary. As the degradation control, the integrated control apparatus 33 can, for example, limit the vehicle speed, change the braking balance, or change a waiting position and a clearance of a target wheel.

Next, an operation when the second control portion 11 malfunctions will be described. The second control portion 11 has the self-diagnosis function. When a failure has occurred in the second control portion 11, the second control portion 11 detects that a failure has occurred in itself by the self-diagnosis function. Since being constructed using the ASILD chipset, the second control portion 11 can detect and process its own abnormality.

The integrated control apparatus 33 detects that the brake motor 2 cannot be driven by the second control portion 11 based on communication information (failure state information of the second control portion 11) from the second control portion 11 using the vehicle data bus 31 or a loss of the information. At the same time, the first control portion 9 detects that the brake motor 2 cannot be driven by the second control portion 11 based on communication information (the failure state information of the second control portion 11) from the second control portion 11 using the communication between the CPUs via the communication line 34, or a loss of the information. The first control portion 9 notifies the integrated control apparatus 33 that a failure has occurred in the second control portion 11.

The second control portion 11 stops the driving of the brake motor 2 by the second control portion 11. The integrated control apparatus 33 determines the condition, and requests the motor control to the first control portion 9. In other words, the integrated control apparatus 33 outputs the control instruction for driving the brake motor 2 to the first control portion 9. Further, the integrated control apparatus 33 performs the degradation control as necessary.

FIG. 3 illustrates the processing performed by the second control portion 11 (M_ECU_2). The control processing illustrated in FIG. 3 is, for example, repeatedly performed per predetermined control cycle (for example, 1 ms).

For example, upon a start of power supply to the second control portion 11, the processing illustrated in FIG. 3 is started. In S1, the second control portion 11 determines whether a failure has occurred in the first control portion 9 (M_ECU_1). More specifically, the second control portion 11 determines whether the current control value of the first motor driving portion 8 by the first control portion 9 is different from the current control value of the second control portion 11 via the phase-current monitor circuit 35. More specifically, the second control portion 11 determines whether the waveform of the phase current in the first motor driving portion 8 falls out of the range of the expected current waveform via the phase-current monitor circuit 35.

If “NO” is determined in S1, i.e., if the waveform of the phase current in the first motor driving portion 8 is determined to be within the range of the expected current waveform, the processing proceeds to S4. On the other hand, if “YES” is determined in S1. i.e., if the waveform of the phase current in the first motor driving portion 8 is determined to fall out of the range of the expected current waveform, the processing proceeds to S2. In S2, the second control portion 11 stops the driving by the first control portion 9. More specifically, in S2, the second control portion 11 stops the driving of the first motor driving portion 8 by the first control portion 9, and thus the driving of the brake motor 2 by the first motor driving portion 8. In this case, the driving of the brake motor 2 by the second control portion 11 (with, for example, an output at 50%) is continued. In S3 subsequent to S2, the second control portion 11 notifies the integrated control apparatus 33, which is the higher-level control apparatus, that “the first motor driving portion 8 is stopped”. Then, the processing proceeds to S4.

In S4, the second control portion 11 determines whether a failure has occurred in the second control portion 11 by the self-diagnosis function. If “NO” is determined in S4, i.e., if the second control portion 11 is determined to have no failure therein, the processing returns to START via RETURN, and is repeated from S1. On the other hand, if “YES” is determined in S4, i.e., if the second control portion 11 is determined to have a failure therein, the processing proceeds to S5. In S5, the second control portion 11 stops the driving of the second motor driving portion 10 by the second control portion 11 and thus the driving of the brake motor 2 by the second motor driving portion 10. In S6 subsequent to S5, the second control portion 11 notifies the integrated control apparatus 33 and the first control portion 9 that “the second motor driving portion 10 is stopped”. Then, the processing returns.

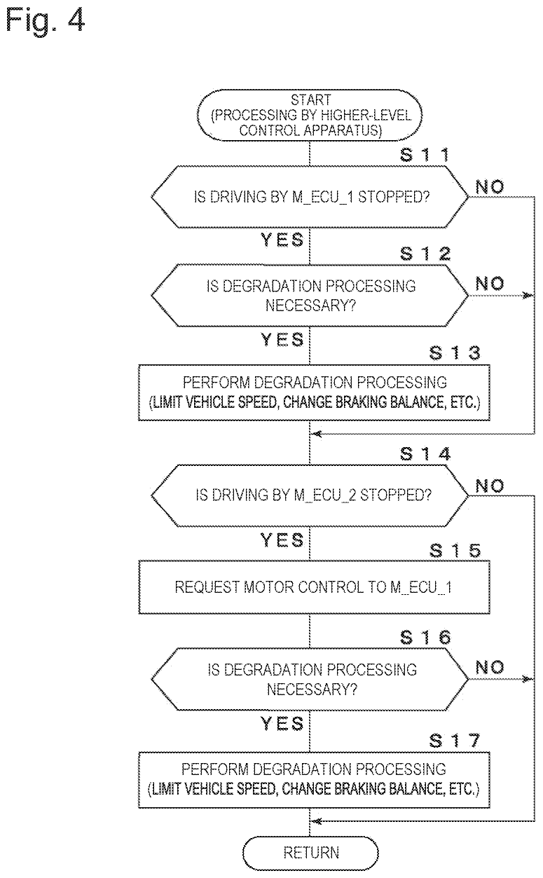

FIG. 4 illustrates the control processing performed by the integrated control apparatus 33, which is the higher-level control apparatus. The control processing illustrated in FIG. 4 is, for example, repeatedly performed per predetermined control cycle (for example, 1 ms).

For example, upon a start of power supply to the integrated control apparatus 33, the processing illustrated in FIG. 4 is started. In S11, the integrated control apparatus 33 determines whether the driving by the first control portion 9 (M_ECU_1) is stopped. More specifically, in S11, the integrated control apparatus 33 determines whether the driving of the first motor driving portion 8 by the first control portion 9 (the driving of the brake motor 2 by the first motor driving portion 8) is stopped. This determination can be made based on, for example, whether the integrated control apparatus 33 is notified by the second control portion 11 (S3 in FIG. 3).

If “NO” is determined in S11, i.e., if the driving by the first control portion 9 (M_ECU_1) is determined not to be stopped, the processing proceeds to S14. On the other hand, if “YES” is determined in S1, i.e., if the driving by the first control portion 9 (M_ECU_1) is determined to be stopped, the processing proceeds to S12. In S12, the integrated control apparatus 33 determines whether the degradation control (for example, limiting the vehicle speed, changing the braking balance, or changing the waiting position and the clearance of the target wheel) is necessary.

If “NO” is determined in S12, i.e., if the degradation control is determined to be unnecessary, the processing proceeds to S14. On the other hand, if “YES” is determined in S12, i.e., if the degradation control is determined to be necessary, the processing proceeds to S13. In S13, the integrated control apparatus 33 performs the degradation control (for example, limits the vehicle speed, changes the braking balance, or changes the waiting position and the clearance of the target wheel). Then, the processing proceeds to S14.

In S14, the integrated control apparatus 33 determines whether the driving by the second control portion 11 (M_ECU_2) is stopped. More specifically, in S14, the integrated control apparatus 33 determines whether the driving of the second motor driving portion 10 by the second control portion 11 (the driving of the brake motor 2 by the second motor driving portion 10) is stopped. This determination can be made based on, for example, whether the integrated control apparatus 33 is notified by the second control portion 11 (S6 in FIG. 3).

If “NO” is determined in S14, i.e., if the driving by the second control portion 11 (M_ECU_2) is determined not to be stopped, the processing returns to START via RETURN, and is repeated from S11. On the other hand, if “YES” is determined in S14, i.e., if the driving by the second control portion 11 (M_ECU_2) is determined to be stopped, the processing proceeds to S15. In S15, the integrated control apparatus 33 requests the motor control to the first control portion 9 (M_ECU_1).

In other words, the integrated control apparatus 33 outputs the control instruction for driving the brake motor 2 to the first control portion 9. As a result, the driving of the brake motor 2 by the first control portion 9 (M_ECU_1) (with, for example, an output at 50%) is continued. In S16 subsequent to S15, the integrated control apparatus 33 determines whether the degradation control (for example, limiting the vehicle speed, changing the braking balance, or changing the waiting position and the clearance of the target wheel) is necessary.

If “NO” is determined in S16, i.e., if the degradation control is determined to be unnecessary, the processing returns. On the other hand, if “YES” is determined in S6, i.e., if the degradation control is determined to be necessary, the processing proceeds to S17. In S17, the integrated control apparatus 33 performs the degradation control (for example, limits the vehicle speed, changes the braking balance, or changes the waiting position and the clearance of the target wheel). Then, the processing returns.

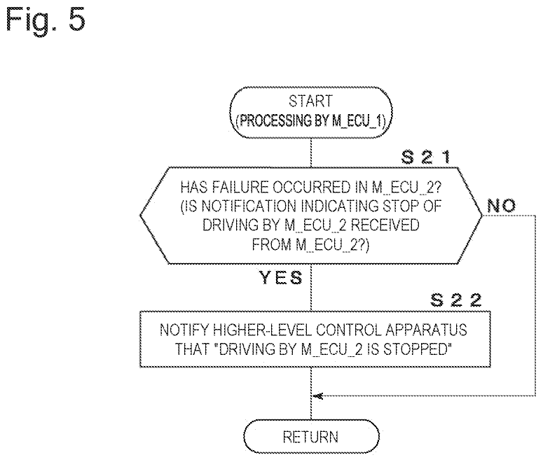

FIG. 5 illustrates the control processing performed by the first control portion 9 (M_ECU_1). The control processing illustrated in FIG. 5 is, for example, repeatedly performed per predetermined control cycle (for example, 1 ms).

For example, upon a start of power supply to the first control portion 9, the processing illustrated in FIG. 5 is started. In S21, the first control portion 9 determines whether a failure has occurred in the second control portion 11 (M_ECU_2). This determination can be made based on, for example, whether the first control portion 9 is notified by the second control portion 11 (S6 in FIG. 3).

If “NO” is determined in S21, i.e., if the second control portion 11 (M_ECU_2) is determined to have no failure therein, the processing returns to START via RETURN, and is repeated from S21. On the other hand, if “YES” is determined in S21, i.e., if the second control portion 11 (M_ECU_2) is determined to have a failure therein, the processing proceeds to S22. In S22, the first control portion 9 notifies the integrated control apparatus 33, which is the higher-level control apparatus, that “the second motor driving portion 10 is stopped”. Then, the processing returns.

In this manner, according to the embodiment, the second control portion 11 has the self-diagnosis function not provided to the first control portion 9. In other words, the first control portion 9 does not have the self-diagnosis function. Therefore, the embodiment can achieve a cost reduction of the first control portion 9. On the other hand, the second control portion 11 monitors the state of the first motor driving portion 8. Therefore, the state of the first motor driving portion 8 and thus the state of the first control portion 9 connected to the first motor driving portion 8 can be monitored by the second control portion 11. Due to that, redundancy can be secured. As a result, the embodiment can achieve both a reduction in the cost of the first control portion 9 and the establishment of redundancy. In other words, the embodiment can achieve a cost reduction while establishing redundancy.

According to the embodiment, the second control portion 11 monitors the state of the phase current in the first motor driving portion 8 by the phase-current monitor circuit 35. Therefore, the second control portion 11 can accurately monitor the state of the first motor driving portion 8 and thus the state of the first control portion 9 by monitoring the state of the current flowing in each of the phases (the U phase, the V phase, and the W phase) of the polyphase alternating-current circuit.

According to the embodiment, the second control portion 11 can determine whether the first control portion 9 is normal or abnormal according to the waveform of the phase current in the first motor driving portion 8 (whether the waveform of the phase current is within the range of the expected current waveform). Therefore, whether the first motor driving portion 8 and thus the first control portion 9 are normal or abnormal can be accurately determined according to the waveform of the phase current.

According to the embodiment, the second control portion 11 can stop the driving of the first motor driving portion 8 when the waveform of the phase current in the first motor driving portion 8 is outside the range of the expected current waveform. As a result, the first motor driving portion 8 can be prevented from operating and thus prevent the brake motor 2 can be prevented from abnormally operating in the state that the waveform of the phase current is outside the range of the expected current waveform.

According to the embodiment, the integrated control apparatus 33 can acquire that the first control portion 9 is abnormal when the waveform of the phase current in the first motor driving portion 8 is outside the range of the expected current waveform. As a result, the integrated control apparatus 33 can perform necessary control when the waveform of the phase current is outside the range of the expected current waveform.

According to the embodiment, the second control portion 11 has the self-diagnosis function. Therefore, the second control portion 11 can determine whether the second control portion 11 itself is normal or abnormal using its own self-diagnosis function.

According to the embodiment, the integrated control apparatus 33 can detect that the second control portion 11 is abnormal based on the fact that the second control portion 11 is determined to be abnormal by the self-diagnosis function of the second control portion 11. Therefore, the integrated control apparatus 33 can perform necessary control such as the degradation control when detecting that the second control portion 11 is abnormal.

According to the embodiment, the second control portion 11 stops the driving of the second motor driving portion 10 when the second control portion 11 is determined to be abnormal by the self-diagnosis function. Therefore, the second control portion 11 can stop the driving of the second motor driving portion 10 when the second control portion 11 itself is determined to be abnormal by the self-diagnosis function of the second control portion 11. As a result, the second motor driving portion 10 can be prevented from operating and thus the brake motor 2 can be prevented from abnormally operating in the state that the second control portion 11 is abnormal.

According to the embodiment, the integrated control apparatus 33 outputs the control instruction for driving the brake motor 2 to the first control portion 9 when the second control portion 11 is determined to be abnormal. Therefore, the integrated control apparatus 33 can drive (continue driving) the motor by the first control portion 9 by outputting the control instruction for driving the brake motor 2 to the first control portion 9 when the second control portion 11 is determined to be abnormal.

According to the embodiment, the brake motor 2 that controls the electric brake mechanism is handled as the motor driven by the first motor driving portion 8 and the second motor driving portion 10. Therefore, the brake motor 2 can be driven by the first motor driving portion 8 connected to the first control portion 9 and the second motor driving portion 10 connected to the second control portion 11.

According to the embodiment, the integrated control apparatus 33, which is the controller of the vehicle, is the integrated controller that determines the motion control of the vehicle. Therefore, the first control portion and the second control portion can be connected to the integrated control apparatus 33 serving as the integrated controller.

The embodiment has been described citing the example in which the second control portion 11 is configured to have the self-diagnosis function not provided to the first control portion 9, i.e., the first control portion 9 is configured not to have the self-diagnosis function. However, without being limited thereto, for example, the second control portion may be configured to have a more accurate self-diagnosis function than the first control portion, i.e., the first control portion may be configured to have a less accurate (less sophisticated) self-diagnosis function than the second control portion. In other words, the first control portion does not have to have all functions in the self-diagnosis function provided to the second control portion.

The embodiment has been described citing the example in which the motor control system 1 has a dual system configuration including the first control portion 9 (the secondary system) and the second control portion 11 (the primary system). However, without being limited thereto, the present invention can be used for, for example, a multisystem configuration including dual or more systems, such as triple systems or quad systems.

The embodiment has been described citing the example in which the brake motor 2, which controls the electric brake mechanism that provides the braking force to the vehicle, is handled as the motor driven by the first motor driving portion 8 and the second motor driving portion 10. However, the motor driven by the first motor driving portion and the second motor driving portion is not limited thereto, and, may be, for example, a steering motor that controls (drives) a steering actuator of a vehicle. In this case, the steering motor can be driven by the first motor driving portion connected to the first control portion and the second motor driving portion connected to the second control portion. In either case, the motor driven by the first motor driving portion and the second motor driving portion is not limited to the brake motor and the steering motor, and can be a motor (a motor for which redundancy should be secured) for driving various kinds of actuators mounted on a vehicle.

The embodiment has been described citing the example in which the controller of the vehicle (the vehicle controller) is the integrated control apparatus 33 (the integrated ECU or the central ECU), which determines the vehicle motion control for moving the vehicle according to the target trajectory acquired from the autonomous driving control apparatus (the autonomous driving ECU). However, without being limited thereto, the controller of the vehicle (the vehicle controller) may be a control apparatus different from the integrated control apparatus 33, such as the steering control apparatus or the suspension control apparatus, i.e., does not have to be a higher-level control apparatus. Various kinds of control apparatuses (ECUs) mounted on a vehicle can be used as the controller of the vehicle (the vehicle controller).

Examples of possible configurations as the motor control apparatus and the motor control system based on the above-described embodiment are as follows.

As a first configuration, a motor control apparatus includes a first motor driving portion configured to drive a motor, a first control portion connected to the first motor driving portion and connected to a controller of a vehicle, and a second control portion connected to the first control portion. The second control portion has a more accurate self-diagnosis function than the first control portion or has a self-diagnosis function not provided to the first control portion. The second control portion is connected to the controller of the vehicle and configured to monitor a state of the first motor driving portion. The motor control apparatus further includes a second motor driving portion connected to the second control portion and configured to drive the motor.

According to this first configuration, the second control portion has a more accurate self-diagnosis function than the first control portion or has a self-diagnosis function not provided to the first control portion. Therefore, the first control portion has no self-diagnosis function, or has a less accurate self-diagnosis function than the second control portion even when having a self-diagnosis function. Therefore, the motor control apparatus can achieve a cost reduction of the first control portion. On the other hand, the second control portion monitors the state of the first motor driving portion. Therefore, the state of the first motor driving portion and thus the state of the first control portion connected to the first motor driving portion can be monitored by the second control portion. Due to that, redundancy can be secured. As a result, the motor control apparatus can achieve both a reduction in the cost of the first control portion and the establishment of redundancy. In other words, the motor control apparatus can achieve a cost reduction while establishing redundancy.

As a second configuration, in the first configuration, the second control portion monitors a state of a phase current in the first motor driving portion.

According to this second configuration, the second control portion can accurately monitor the state of the first motor driving portion and thus the state of the first control portion by monitoring the state of the phase current in the first motor driving portion, i.e., the state of a current flowing in each of phases (a U phase, a V phase, and a W phase) of a polyphase alternating-current circuit.

As a third configuration, in the second configuration, the second control portion determines that the first control portion is normal in a case where a waveform of the phase current in the first motor driving portion is within a range of an expected current waveform, and determines that the first control portion is abnormal in a case where the waveform of the phase current in the first motor driving portion is outside the range of the expected current waveform.

According to this third configuration, whether the first control portion is normal or abnormal can be determined according to the waveform of the phase current in the first motor driving portion (whether the waveform of the phase current is within the range of the expected current waveform). Therefore, whether the first motor driving portion and thus the first control portion are normal or abnormal can be accurately determined according to the waveform of the phase current.

As a fourth configuration, in the second configuration, the second control portion stops driving of the first motor driving portion in a case where a waveform of the phase current in the first motor driving portion is outside a range of an expected current waveform.

According to this fourth configuration, the driving of the first motor driving portion can be stopped in the case where the waveform of the phase current in the first motor driving portion is outside the range of the expected current waveform. As a result, the first motor driving portion can be prevented from operating and thus the motor can be prevented from abnormally operating in the state that the waveform of the phase current is outside the range of the expected current waveform.

As a fifth configuration, in the fourth configuration, the second control portion notifies the controller of the vehicle that the first control portion is abnormal in the case where the waveform of the phase current in the first motor driving portion is outside the range of the expected current waveform.

According to this fifth configuration, the controller of the vehicle can acquire that the first control portion is abnormal in the case where the waveform of the phase current in the first motor driving portion is outside the range of the expected current waveform. As a result, the controller of the vehicle can perform necessary control in the case where the waveform of the phase current is outside the range of the expected current waveform.

As a sixth configuration, in the first configuration, the second control portion determines whether the second control portion is normal or abnormal by the self-diagnosis function.

According to this sixth configuration, the second control portion can determine whether the second control portion itself is normal or abnormal using its own self-diagnosis function.

As a seventh configuration, in the sixth configuration, the controller of the vehicle detects that the second control portion is abnormal in a case where the second control portion is determined to be abnormal by the self-diagnosis function.

According to this seventh configuration, the controller of the vehicle can detect that the second control portion is abnormal based on the fact that the second control portion is determined to be abnormal by the self-diagnosis function of the second control portion. The controller of the vehicle can perform the necessary control when detecting that the second control portion is abnormal.

As an eighth configuration, in the seventh configuration, the second control portion stops driving of the second motor driving portion in the case where the second control portion is determined to be abnormal by the self-diagnosis function.

According to this eighth configuration, the second control portion can stop the driving of the second motor driving portion in the case where the second control portion itself is determined to be abnormal by the self-diagnosis function of the second control portion. As a result, the second motor driving portion can be prevented from operating and thus the motor can be prevented from abnormally operating in the state that the second control portion is abnormal.

As a ninth configuration, in the sixth configuration, the controller of the vehicle outputs a control instruction for driving the motor to the first control portion in a case where the second control portion is determined to be abnormal by the self-diagnosis function.

According to this ninth configuration, the controller of the vehicle can drive (continue driving) the motor by the first control portion by outputting the control instruction for driving the motor to the first control portion when the second control portion is determined to be abnormal.

As a tenth configuration, in the first configuration, the motor is a brake motor configured to control an electric brake mechanism that provides a braking force to the vehicle.

According to this tenth configuration, the brake motor can be driven by the first motor driving portion connected to the first control portion and the second motor driving portion connected to the second control portion.

As an eleventh configuration, in the first configuration, the motor is a steering motor configured to control a steering actuator of the vehicle.

According to this eleventh configuration, the steering motor can be driven by the first motor driving portion connected to the first control portion and the second motor driving portion connected to the second control portion.

As a twelfth configuration, in the first configuration, the controller of the vehicle is an integrated controller configured to determine motion control of the vehicle.

According to this twelfth configuration, the first control portion and the second control portion can be connected to the integrated controller, which is the controller of the vehicle.

As a thirteenth configuration, a motor control system includes a motor and a motor controller configured to control the motor. The motor controller includes a first motor driving portion configured to drive the motor, a first control portion connected to the first motor driving portion, and a second control portion connected to the first control portion. The second control portion has a more accurate self-diagnosis function than the first control portion or has a self-diagnosis function not provided to the first control portion. The second control portion is configured to monitor a state of the first motor driving portion. The motor controller further includes a second motor driving portion connected to the second control portion and configured to drive the motor. The motor control system further includes a vehicle controller connected to the first control portion and the second control portion.

According to this thirteenth configuration, the second control portion has a more accurate self-diagnosis function than the first control portion or has a self-diagnosis function not provided to the first control portion. Therefore, the first control portion has no self-diagnosis function, or has a less accurate self-diagnosis function than the second control portion even when having a self-diagnosis function. Therefore, the motor control system can achieve a cost reduction of the first control portion. On the other hand, the second control portion monitors the state of the first motor driving portion. Therefore, the state of the first motor driving portion and thus the state of the first control portion connected to the first motor driving portion can be monitored by the second control portion. Due to that, redundancy can be secured. As a result, the motor control system can achieve both a reduction in the cost of the first control portion and the establishment of redundancy. In other words, the motor control system can achieve a cost reduction while establishing redundancy.

The present invention shall not be limited to the above-described embodiment, and includes various modifications. For example, the above-described embodiment has been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each embodiment can also be implemented with another configuration added, deleted, or replaced with respect to a part of the configuration of this embodiment.

The present application claims priority under the Paris Convention to Japanese Patent Application No. 2020-207400 filed on Dec. 15, 2020. The entire disclosure of Japanese Patent Application No. 2020-207400 filed on Dec. 15, 2020 including the specification, the claims, the drawings, and the abstract is incorporated herein by reference in its entirety.

### REFERENCE SIGNS LIST

1 motor control system
2 brake motor (motor)
7 motor control apparatus (motor controller)
8 first motor driving portion
9 first control portion
10 second motor driving portion
11 second control portion
33 integrated control apparatus (controller of vehicle, vehicle controller, and integrated controller)
34 communication line
35 phase-current monitor circuit

1. A motor control apparatus, comprising:
a first motor driving portion configured to drive a motor;
a first control portion connected to the first motor driving portion and connected to a controller of a vehicle;
a second control portion connected to the first control portion, the second control portion having a more accurate self-diagnosis function than the first control portion or having a self-diagnosis function not provided to the first control portion, the second control portion being connected to the controller of the vehicle and configured to monitor a state of the first motor driving portion; and
a second motor driving portion connected to the second control portion and configured to drive the motor.

2. The motor control apparatus according to claim 1, wherein the second control portion monitors a state of a phase current in the first motor driving portion.

3. The motor control apparatus according to claim 2, wherein the second control portion determines that the first control portion is normal in a case where a waveform of the phase current in the first motor driving portion is within a range of an expected current waveform, and determines that the first control portion is abnormal in a case where the waveform of the phase current in the first motor driving portion is outside the range of the expected current waveform.

4. The motor control apparatus according to claim 2, wherein the second control portion stops driving of the first motor driving portion in a case where a waveform of the phase current in the first motor driving portion is outside a range of an expected current waveform.

5. The motor control apparatus according to claim 4, wherein the second control portion notifies the controller of the vehicle that the first control portion is abnormal in the case where the waveform of the phase current in the first motor driving portion is outside the range of the expected current waveform.

6. The motor control apparatus according to claim 1, wherein the second control portion determines whether the second control portion is normal or abnormal by the self-diagnosis function.

7. The motor control apparatus according to claim 6, wherein the controller of the vehicle detects that the second control portion is abnormal in a case where the second control portion is determined to be abnormal by the self-diagnosis function.

8. The motor control apparatus according to claim 7, wherein the second control portion stops driving of the second motor driving portion in the case where the second control portion is determined to be abnormal by the self-diagnosis function.

9. The motor control apparatus according to claim 6, wherein the controller of the vehicle outputs a control instruction for driving the motor to the first control portion in a case where the second control portion is determined to be abnormal by the self-diagnosis function.

10. The motor control apparatus according to claim 1, wherein the motor is a brake motor configured to control an electric brake mechanism that provides a braking force to the vehicle.

11. The motor control apparatus according to claim 1, wherein the motor is a steering motor configured to control a steering actuator of the vehicle.

12. The motor control apparatus according to claim 1, wherein the controller of the vehicle is an integrated controller configured to determine motion control of the vehicle.

13. A motor control system, comprising:
a motor;
a motor controller configured to control the motor, the motor controller including a first motor driving portion configured to drive the motor,
a first control portion connected to the first motor driving portion,
a second control portion connected to the first control portion, the second control portion having a more accurate self-diagnosis function than the first control portion or having a self-diagnosis function not provided to the first control portion, the second control portion being configured to monitor a state of the first motor driving portion, and
a second motor driving portion connected to the second control portion and configured to drive the motor; and
a vehicle controller connected to the first control portion and the second control portion.
